(19) United States
(12) Patent Application Publication
(10) Pub. No.: US 2008/0292815 A1
(43) Pub. Date: Nov. 27, 2008

(54) METHOD FOR PRODUCING RESIN-COATED SLIDING MEMBER

(75) Inventors: Hideki Iwata, Inuyama (JP); Toshihiko Takagi, Inuyama (JP); Naoki Touge, Inuyama (JP); Hideyuki Nakajima, Inuyama (JP)

Correspondence Address: BROWDY AND NEIMARK, P.L.L.C.;624 NINTH STREET, NW, SUITE 300, WASHINGTON, DC, 20001-5303, US

(73) Assignee: DAIDO METAL COMPANY LTD., Nagoya (JP)

(21) Appl. No.: 12/127,723

(22) Filed: May 27, 2008

(30) Foreign Application Priority Data
May 25, 2007 (JP) 2007-139564

(51) Int. Cl. B05D 3/06

(52) U.S. Cl. 427/595

(57) ABSTRACT

The present invention provides a method for producing a resin-coated sliding member in which problems such as blistering do not occur even if drying of the solvent is carried out rapidly, and in which quality is also stabilized. The method includes an impregnating step for impregnating a solvent-containing resin composition by a resin impregnating apparatus 12 into a porous sintered layer sintered on a back metal 11, a drying step for drying with a drying furnace 13 the solvent in the resin composition impregnated in the porous sintered layer using an electromagnetic wave oscillator which radiates electromagnetic waves in a wavelength region which is easily absorbed in the solvent, and a baking step for baking with a baking furnace 14 the resin composition impregnated in the porous sintered layer.

### BACKGROUND OF THE INVENTION

The present invention relates to a method for producing a resin-coated sliding member which is produced by coating a solvent-containing resin composition on a back metal or impregnating the solvent-containing resin composition into a porous sintered layer sintered on the back metal, drying and then baking.

Conventionally, resin-coated sliding members have been produced by impregnating and coating a resin composition containing a solvent (e.g., toluene) in a resin, such as PTFE or PAI, on a steel back metal (steel strip) sintered with a copper or bronze powder, then drying and baking. During the production of such a resin-coated sliding member, for reasons such as viscosity adjustment and impregnating properties, the addition of a solvent to the resin composition is essential. Thus, a drying step prior to baking has also been necessary.

However, if rapid heating is carried out using an electric resistance furnace and the like to remove the solvent, a film is formed on the top surface of the resin. The solvent inside the resin subsequently evaporates as a gas, pushing up the film, whereby blistering occurs. To make sure that this blistering does not occur, it is necessary to take time for the heating. To resolve this problem, a method has been proposed which provides the heating up and keeping of temperature to and at the drying temperature by high-frequency induction heating, as described in the following Patent Document 1.

Patent Document 1: Japanese Patent No. 3842635 (claims 1 and 2, and paragraphs 0009 and 0010)

Patent Document 1 describes directly heating a back metal by high-frequency induction heating whereby drying occurs from the resin layer side in contact with the back metal with the conduction of heat to prevent blistering of the top surface of the resin from occurring. High-frequency induction heating will now be described using the most common example of a solenoid coil system. A target heating metal is inserted in the high-frequency induction coil so as not to be in contact with each other, then an alternating current is flowed in the high-frequency induction coil to generate a magnetic flux. If this magnetic flux is made to penetrate only the surface portion of the target heating metal, because an induced current is flowing in the target heating metal so as to negate this magnetic flux, Joule heating occurs as a result of the electric resistance in the metal. However, if the target heating metal is a thin sheet, the magnetic flux density generated from the high-frequency induction coil is higher at the center portion of the sheet in a width direction than at the end portions, so that the heating temperature is higher. This makes it difficult to heat uniformly. Although various proposals have been made to alleviate the non-uniform heating of a thin sheet of metal, for steel strips or steel sheets having the most common thickness of about 0.5 to 3 mm at the back metal of the resin-coated sliding member, an effective means to resolve this problem is yet to be completed because, in part, of there are limits on the magnetic flux penetration depth. Therefore, if a steel back metal is heated by high-frequency induction heating as described in Patent Document 1, so that the transmitted heat dries the solvent in the coated resin, a difference in drying degree develops between the center portion and the edge portions of the resin-coated sliding member. As a result, the quality after the resin has been baked is not uniform. The present invention was created in view of the above-described circumstances, and it is an object of the present invention to provide a method for producing a resin-coated sliding member in which problems such as blistering do not occur even if drying of the solvent is carried out rapidly, and in which quality is also stabilized.

### SUMMARY OF THE INVENTION

To achieve the above-described object, the first aspect of the present invention provides a method for producing a resin-coated sliding member which is produced by coating a solvent-containing resin composition on a back metal, drying and then baking, the method comprising a coating step for coating the solvent-containing resin composition on the back metal, a drying step for drying the solvent in the resin composition coated on the back metal using an electromagnetic wave oscillator which radiates electromagnetic waves in a wavelength region which is easily absorbed in the solvent, and a baking step for baking the resin composition coated on the back metal.

Here, infrared rays in a wavelength region easily absorbed in the solvent are absorbed in the solvent, whereby the oscillation frequency of the electromagnetic waves having those infrared rays and the oscillation frequency of the molecular structure constituting the solvent are made to resonate, and the solvent itself generates heat. The above-described drying step utilizes this principle.

Therefore, the solvent preferentially generates heat as compared with the resin at any site of the resin-coated sliding member, and is dried. As a result, rapid heating can be carried out without blistering occurring on the resin top surface film. Further, since the drying is caused by self-heating as a result of the solvent resonance, the drying can be carried out uniformly at any site of the resin-coated sliding member. To cause resonance to occur at the characteristic frequency of various typical solvents used in the production of resin-coated sliding members, electromagnetic waves having a wavelength of 0.4 to 50 μm may be selected.

Further, the second aspect of the present invention provides a method for producing a resin-coated sliding member which is produced by impregnating a solvent-containing resin composition into a porous sintered layer sintered on a back metal, drying and then baking, the method comprising an impregnating step for impregnating the solvent-containing resin composition into the porous sintered layer sintered on a back metal, a drying step for drying the solvent in the resin composition impregnated in the porous sintered layer using an electromagnetic wave oscillator which radiates electromagnetic waves in a wavelength region which infiltrates into voids in the porous sintered layer and which is easily absorbed in the solvent, and a baking step for baking the resin composition impregnated in the porous sintered layer.

Here, although the effects of the electromagnetic waves having a wavelength which infiltrates into voids in the porous sintered layer and which is easily absorbed in the solvent are as described above, electromagnetic waves in this wavelength region are almost entirely reflected by the porous sintered layer or a metal surface such as the back metal, and do not pass through the metal. Thus, the electromagnetic waves are infiltrated (transmitted) from large voids on the surface side of the porous sintered layer to voids inside the porous sintered layer, whereby the solvent in the voids is heated and dried. Although the voids on the surface side of the porous sintered layer of the resin-coated sliding member are large enough for the electromagnetic waves to have no problems in infiltrating therein, the voids in the sintered portions among the metal powders inside the porous sintered layer are, at their narrowest, often about 30 μm. Accordingly, electromagnetic waves having a wavelength of not more than 30 μm which can infiltrate into at least such a void must be selected. Therefore, electromagnetic waves having a wavelength of 0.4 to 30 μm are preferred. For electromagnetic waves having a wavelength of more than 30 μm, which do not easily infiltrate into the portions having the narrowest diameters of the voids in the porous sintered layer, the drying of the resin containing a solvent which has impregnated into the deepest portions of the porous sintered layer may not be sufficient.

Further, in the second aspect of the present invention, the electromagnetic wave oscillator is preferably an infrared light source, and the electromagnetic waves are preferably infrared rays with a wavelength of 0.4 to 10 μm.

Here, by using an infrared light source as the electromagnetic wave oscillator, the infrared light source itself becomes a heat source while simultaneously generating electromagnetic waves, and from the resulting radiant heat the atmosphere inside the drying furnace is also heated. As a result, the heat transfer loss of the solvent to the atmosphere from electromagnetic wave absorption decreases, so that it is possible to heat even more rapidly. In addition, since the furnace temperature is also uniformly heated by the radiant heat, the drying quality is stabilized. Further, by making the electromagnetic waves infrared rays with a wavelength of 0.4 to 10 μm, since the wavelength is sufficiently shorter than the diameter of the narrowest portions of the voids in the porous sintered layer, the solvent-containing resin can be sufficiently dried because the electromagnetic waves are infiltrated even to the deepest portions of the porous sintered layer without the electromagnetic field intensity attenuating in the porous sintered layer.

In the first aspect of the present invention, a method is employed for the drying step which dries the solvent in the resin composition coated on the back metal using an electromagnetic wave oscillator which radiates electromagnetic waves in a wavelength region which is easily absorbed in the solvent, which causes the solvent itself to preferentially self-heat. As a result, even with rapid heating, the occurrence of blistering can be prevented by drying the solvent without forming a film on the top surface of the resin, thereby also allowing quality to be stabilized.

Further, in the second aspect of the present invention, by using electromagnetic waves having a wavelength which infiltrates into voids in the porous sintered layer and which is easily absorbed in the solvent, even with rapid heating the occurrence of blistering can be prevented by drying the solvent impregnated inside the porous sintered layer, thereby also allowing quality to be stabilized.

Further, in the second aspect of the present invention, by using the electromagnetic wave oscillator, as an infrared light source and making the electromagnetic waves infrared rays with a wavelength of 0.4 to 10 μm, even with rapid heating the occurrence of blistering can be prevented by drying even the solvent impregnated in the deepest portions inside the porous sintered layer. In addition to this, by also uniformly heating the atmosphere temperature in the drying furnace by the radiant heat from the electromagnetic wave oscillator, the drying quality can be stabilized even further. To uniformly irradiate the whole of the resin-coated sliding member, an arrangement can be employed which adjusts the angle of the infrared rays from the electromagnetic wave oscillator using a mirror.

### BRIEF DESCRIPTION OF THE SEVERAL VIEWS OF THE DRAWING

FIG. 1 is a schematic illustration showing the production steps of a resin-coated sliding member according to the present embodiment; and

FIGS. 2A and 2B are schematic illustrations showing the reflected state of the electromagnetic waves in the drying step.

### DESCRIPTION OF REFERENCE NUMERALS

2 Back metal
3 Porous sintered layer
4 Resin composition
10 Uncoiler
11 Back metal
12 Resin impregnating apparatus
13 Drying furnace
14 Baking furnace
15 Cooling zone
16 Coiler

### DETAILED DESCRIPTION OF THE INVENTION

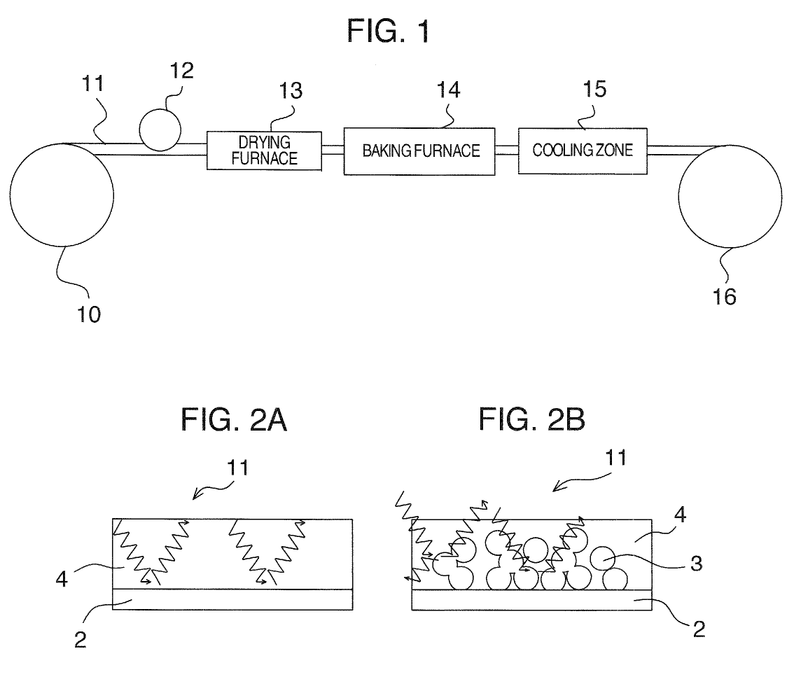

An embodiment of the present invention will now be described. FIG. 1 is a schematic illustration showing the production steps of a resin-coated sliding member according to the present embodiment, and FIGS. 2A and 2B are schematic illustrations showing the reflected state of the electromagnetic waves in the drying step.

In FIG. 1, a solvent-containing resin composition is coated on or impregnated into a back metal 11 (this back metal 11 is the same as that on which a porous sintered layer 3 is sintered to the back metal 2 of FIG. 2A or back metal 2 of FIG. 2B) having a porous sintered layer fed from an uncoiler 10 by a resin impregnating apparatus 12 (coating or impregnating step). Then, the solvent is evaporated by the drying furnace 13 having an electromagnetic wave oscillator which radiates electromagnetic waves into the interior (drying step). The back metal having a porous sintered layer according to the present embodiment is obtained by, for example, spreading copper alloy powder to a thickness of 0.3 mm on a steel sheet (back metal) having a thickness dimension of 1.2 mm, and then sintering the copper alloy powder by heating to a temperature of 750 to 900° C. in a reducing atmosphere.

Further, in the above-described drying process, a halogen lamp is used as the electromagnetic wave oscillator arranged in the drying furnace 13. The infrared rays irradiated from the halogen lamp are electromagnetic waves in a wavelength region which is easily absorbed in the solvent in the resin composition but hardly absorbed in the resin. Specifically, if the solvent is toluene and the resin is PTFE, a wavelength region of 0.4 to 50 μm is preferred. By irradiating electromagnetic waves in this wavelength region, the solvent is selectively heated to a temperature higher than the temperature of the resin and the back metal (having the relationship: solvent temperature>resin temperature>back metal temperature). As a result, the solvent can be evaporated to dry the resin composition without a film being formed on the top surface of the resin. Further, electromagnetic waves in the wavelength according to the present invention have high linearity, like light. Thus, the present invention can be configured so that the electromagnetic waves radiated from the electromagnetic wave oscillator are uniformly irradiated over the whole surface of the resin composition using a mirror, which allows the drying to be carried out without any uniformity over the whole resin composition. In addition to a halogen lamp, a xenon lamp, a xenon flash lamp, a mercury lamp and the like can be used as the electromagnetic wave oscillator.

Although the present embodiment is described as an example according to the second aspect of the present invention, in the case of a resin-coated sliding member having the resin composition directly coated on the back metal, which is an embodiment according to the first aspect of the present invention, as shown in FIG. 2A, the electromagnetic waves are reflected in one direction at the boundary between the back metal 2 and the resin composition 4. When the resin composition is impregnated onto the back metal via a porous sintered layer, like the resin-coated sliding member of the present embodiment according to the second aspect of the present invention, as shown in FIG. 2B, coupled with the fact that the wavelength of the electromagnetic waves is short, the electromagnetic waves can reach the interior of the porous sintered layer 3, and are transmitted while being reflected in a scattered manner by the porous sintered layer 3. As a result, the probability of the electromagnetic waves being absorbed in the solvent increases, whereby the solvent is heated more uniformly and in a shorter time. This means that the drying time can be shortened. Further, by making the electromagnetic waves infrared rays with a wavelength of 0.4 to 10 μm, the rays are transmitted to the deepest portions of the porous sintered layer 3 without the electromagnetic field intensity attenuating. As a result, the solvent can be heated even more uniformly and in an even shorter time. Further, if an infrared light source is used as the electromagnetic wave oscillator, the atmosphere temperature in the drying furnace is also heated uniformly by the radiant heat from the infrared light source, so that the quality after drying is more stable.

Returning to FIG. 1, following the above-described drying step, baking is carried out with a baking furnace 14 to bake the dried resin composition (baking step). In this baking step, in the case of PTFE resin, the baking is carried out at a temperature equal to or higher than the melting point, but lower than the decomposition temperature. In the case of a thermosetting resin, the baking is carried out at a temperature equal to or higher than the curing initiation temperature. Further, examples of the baking furnace 14 structure include a high-frequency induction heating furnace, an electric furnace and a gas furnace.

Following the baking step, the baked resin-coated back metal 11 is cooled to room temperature at a cooling zone 15, and then wound by a coiler 16. The cooling in the cooling zone 15 may be carried out by air cooling, water cooling or a combination thereof, so long as the cooling cools to room temperature. Further, a sizing step for controlling the total thickness of the resin coated back metal 11 may be added between the cooling zone 15 and the coiler 16.

In the above-described embodiment of the present invention PTFE resin was used as the resin composition. However, other resins may be used, such as PEEK, PI, PAI, PES, PPS, POM. Further, N-methyl-2-pyrrolidone (NMP), xylene, methyl ethyl ketone (MEK), dimethylacetamide (DMAC) and the like may be used as the solvent. In addition, various metals or alloys other than steel may be used as the back metal. Further, a solid lubricant, such as MoS₂ and graphite, hard particles and the like may be mixed in the resin.

What is claimed is:

1. A method for producing a resin-coated sliding member which is produced by coating a solvent-containing resin composition on a back metal, drying and then baking, the method comprising:
a coating step for coating the solvent-containing resin composition on the back metal;
a drying step for drying the solvent in the resin composition coated on the back metal using an electromagnetic wave oscillator which radiates electromagnetic waves in a wavelength region which is easily absorbed in the solvent; and
a baking step for baking the resin composition coated on the back metal.

2. A method for producing a resin-coated sliding member which is produced by impregnating a solvent-containing resin composition into a porous sintered layer sintered on a back metal, drying and then baking, the method comprising:
an impregnating step for impregnating the solvent-containing resin composition into the porous sintered layer sintered on a back metal;
a drying step for drying the solvent in the resin composition impregnated in the porous sintered layer using an electromagnetic wave oscillator which radiates electromagnetic waves in a wavelength region which infiltrates into voids in the porous sintered layer and which is easily absorbed in the solvent; and
a baking step for baking the resin composition impregnated in the porous sintered layer.

3. A method for producing a resin-coated sliding member according to claim 2, wherein the
electromagnetic wave oscillator is an infrared light source, and the electromagnetic waves are infrared rays with a wavelength of 0.4 to 10 μm.
